(19) United States
(12) Patent Application Publication
(10) Pub. No.: US 2010/0172437 A1
(43) Pub. Date: Jul. 8, 2010

(54) Signal pre-processor for an amplifying system

(75) Inventors: Stephen Phillip Brown, Letchworth (GB); Robert Julian Francis Hughes, St Neots (GB); Anthony Duncan Craig, Hitchin (GB)

Correspondence Address: NIXON & VANDERHYE, PC, 901 NORTH GLEBE ROAD, 11TH FLOOR, ARLINGTON, VA, 22203, US

(73) Assignee: ASTRIUM LIMITED, Stevenage (GB)

(21) Appl. No.: 12/385,920

(22) Filed: Apr. 24, 2009

(30) Foreign Application Priority Data
Jan. 5, 2009 (GB) GB0900045.6

(51) Int. Cl. H04L 25/49

(52) U.S. Cl. 375/296

(57) ABSTRACT

A signal pre-processor, for at least partially correcting non-linear performance of a high power amplifier (“HPA”), operates on an over-sampled signal in complex form in the digital domain. By converting the over-sampled signal to amplitude values, the pre-processor is enabled to apply correction values, based on the amplitude values, which correction values incorporate both amplitude and phase correction in respect of distortion generated in the HPA. The use of an over-sampled signal allows out-of-band correction values to be applied to correct out-of-band distortion arising in the signal processing path, for instance in the linearization process itself. The out-of-band distortion can otherwise alias back in-band, creating noise at the HPA.

The present invention relates to a signal pre-processor for an amplifying system. Embodiments of the invention find particular application in power amplifier arrangements and more particularly to the reduction of distortion in the amplifier output, for instance in environments such as communications satellites where mass and power are critical parameters and efficiency and linearity in amplification arrangements are of high importance.

A power amplifier, or high power amplifier (“HPA”), is generally one designed with power efficiency as a primary criterion and will be used for example for the output stage of a signal transmission path. A HPA has a high output power level, usually measured in decibels (“dB”), relative to the environment in which it will be used.

There are known problems with distortion in the performance of high power amplifiers (“HPA”s). A first example is saturation in which the input signal is at a power level higher than the amplifier is designed or configured to take. The input signal can be reduced in power but this degrades the signal to noise ratio. A second example is distortion in which non-linearity in the response of the HPA produces signal degradation. In general, linearity tends to be achieved at the expense of efficiency. The power level in the HPA can be reduced (known as “backing off” the HPA) so as to control signal degradation but this reduces efficiency. An example of such distortion occurs where non-linearity in the performance of the HPA supports inter-modulation products of the different carriers in a multi-carrier environment. Additionally, multi-carrier systems have large peak-to-mean ratios which mean they're particularly susceptible to degradation by non-linearity in the amplifier.

It is known to use a lineariser to pre-distort the signal input to the HPA in an inverse manner, using modelling of the HPA behaviour in order to calculate a pre-distortion characteristic. Attention has been given to particular models and modelling techniques. For example, U.S. Pat. No. 6,307,435 (Nguyen et al) uses a modified linear-log model in order to calculate a pre-distortion characteristic for reducing spectral re-growth and clipping effects through the peak operating point of a HPA.

U.S. Pat. No. 5,937,011 (Carney et al) discloses a distortion correction technique in a multi-carrier radio signalling system such as a cellular base station. Feedback from the output of a HPA is down-converted, digitised and compared with a broadband composite input signal to load offset values to lookup tables for use in pre-distortion. The system is re-calibrated periodically by connecting the output of the HPA to a high power dummy load. This arrangement corrects amplitude distortion and provides self-calibration over time but does not deal with phase distortion and requires input data in the form of a real time series.

Agilent Technologies have published a design guide based on a linearisation module for use with two other Agilent products: a generic signal generator and a vector signal analyser. The module uses an output signal from an amplifier to calculate a complex weight (a function of amplitude) to apply adaptively as pre-distortion of the input signal to the amplifier. However, although the complex weight is calculated in the digital domain and stored in lookup tables, the linearization is applied as gain adjustment in the analogue domain.

According to a first aspect of embodiments of the present invention, there is provided a signal pre-processor for an amplifying system, for use in providing a multiplexed, multi-carrier signal to an amplifier to give an amplified signal comprising a wanted frequency range, the pre-processor comprising:
a) a sample rate setting arrangement for providing a digital, multiplexed signal as an over-sampled signal in complex form, the signal being over-sampled with respect to the wanted frequency range;
b) an amplitude processor for receiving the over-sampled signal and processing it to obtain a set of amplitude values;
c) an amplitude value converter for converting at least some of the amplitude values to complex correction values; and
d) a signal correcting processor for applying the complex correction values to the over-sampled signal to create a pre-distorted digital signal, prior to amplification by the amplifier,
   such that signal distortion in the amplified signal can be at least partially avoided.

The signal pre-processor will generally have an input bandwidth which is a fixed system constraint, dependent on the system in which the pre-processor is being applied. It will usually be determined for example by the wanted frequency range of the signal output of the amplifier. This wanted frequency range will usually be determined for example by the signal the amplifier is designed to provide for subsequent use.

In the above, the amplitude processor requires the over-sampled signal to be in complex form. If a digital, multiplexed signal is received for pre-processing in real form, the pre-processor may comprise a filter for use in converting a real signal to provide the over-sampled signal in complex form. In practice, although different elements might be present to provide different functions, the sample rate setting arrangement may itself provide more than one function. For example, it might provide both over-sampling and real-to complex conversion.

Over-sampling is intended here to have the established meaning that a signal is sampled at a rate above critical sampling. Critical sampling is the minimum rate required to avoid aliasing in digitising a signal. Where a complex digital signal is concerned, a critically sampled signal has a bandwidth equal to the sampling rate.

Embodiments of the present invention offer a particularly effective arrangement for implementing pre-distortion to achieve linearization of performance of a HPA and/or to reduce or remove inter-modulation products supported by the HPA. A strength of these embodiments is in the implementation rather than in any particular model of HPA performance. For example, importantly, pre-distortion is applied in the digital domain. In order to deal effectively with inter-modulation products, over-sampling prior to pre-distortion is applied. The over-sampling doesn't add information to the received signal but it lays a basis on which pre-distortion can more accurately counteract distortion introduced to the received signal by signal processing and/or at the HPA. By over-sampling, it is possible to create pre-distortion in the digital domain to correct inter-modulation products arising in the HPA without introducing unacceptable noise by way of the linearization process itself. The over-sampling reduces the number of out-of-band intermodulation products generated by the pre-distortion process that alias into the wanted band-width. Under ideal circumstances, distortion created in the linearization process and non-linearity of the HPA are both cancelled out exactly in the signal after it has been amplified by the HPA. Without oversampling, aliased intermodulation products will not be cancelled out and thus may contribute noise to the wanted signal.

It may not always be necessary to apply complex correction values to all the values obtained by the over-sampling but, conversely, in most cases it will be preferred. If complex correction values are not applied to all the values, this would generally in itself introduce non-linear distortion. The amplitude value converter will usually therefore convert all of the amplitude values to complex correction values. However, there may be cases where for example it is sufficient to calculate the correction factor at a reduced rate but still apply the resulting correction factor to every sample. For example, the amplitude of every third sample might be calculated and used to determine a correction factor which is applied to the sample for which it was calculated and also the next two samples, the process then being repeated.

Further, by using amplitude values of the over-sampled signal, it is possible to pre-distort the over-sampled signal so as to deal with phase distortion as well as amplitude distortion because the phase distortion has a relationship with the amplitude of the signal being amplified. That is, the complex correction values can take into account both the amplitude-phase characteristic of the HPA and the amplitude-amplitude characteristic. In this respect, pre-distortion to deal with phase distortion needs to take into account the pre-distortion designed to deal with amplitude distortion. Hence any phase correction is preferably applied in respect of the already amplitude-corrected signal.

Embodiments of the present invention can optimise output efficiency and linearity across a full range of operating powers of an HPA and, importantly, are not specific to a particular type of HPA. They are flexible in terms of input data, which can be real or complex and sampled at a rate as low as critically sampled.

The amplitude value converter may simply comprise a data reader for reading correction values in relation to the amplitude values from a data store, such as one or more look up tables. A data store can be easily updated, extended or changed so as to deal as necessary with different types of HPA, with local conditions such as temperature and with changes over time.

According to a second aspect of the present invention, there is provided a method of processing a multiplexed, multi-carrier signal, for use in providing a pre-distorted signal to an amplifier for amplification to give an amplified signal comprising a wanted frequency range, the method comprising:
a) receiving the multiplexed signal and processing it to provide an over-sampled digital signal in complex form;
b) processing the over-sampled signal to obtain a set of amplitude values;
c) converting at least some of the amplitude values to complex correction values; and
d) applying the complex correction values to the over-sampled digital signal to create the pre-distorted signal,
   such that signal distortion in the amplified signal is at least partially avoided.

The bandwidth of the multiplexed signal will generally conform to a fixed system constraint, dependent on the system in which the pre-distorted signal is to be created. Over-sampling in this context will generally be in relation to the bandwidth of the system and usually that of the system component supplying the multiplexed signal for over-sampling. The general aim of the over-sampling however will be to over-sample in relation to the critical sampling rate of the wanted frequency range.

Embodiments of the invention might be used for example in a communications satellite to linearise the signal supplied to a transmitting antenna or to an array of antennas. Hence, according to a third aspect of the present invention, there is provided a communications satellite having a digital processor architecture and comprising a digital multiplexer for generating a multiplex of carriers and a high power amplifier for amplifying the multiplex of carriers, the satellite further comprising a signal pre-processor as described above, for use in delivering the multiplex of carriers to the high power amplifier. In practice, the multiplexer of the satellite might provide the rate setting arrangement of the pre-processor.

A pre-distortion lineariser for a high power amplifier will now be described as an embodiment of the present invention, by way of example only, with reference to the accompanying drawings in which:

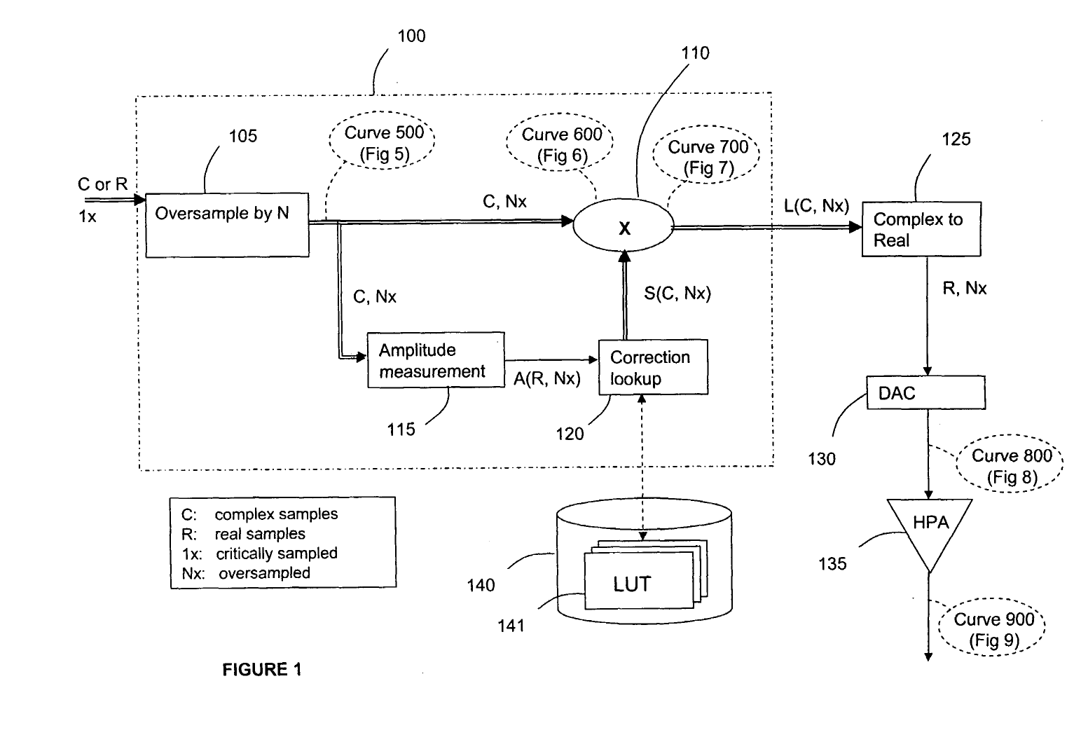

FIG. 1 shows a functional block diagram of primary components of the lineariser connected to the input of an HPA;

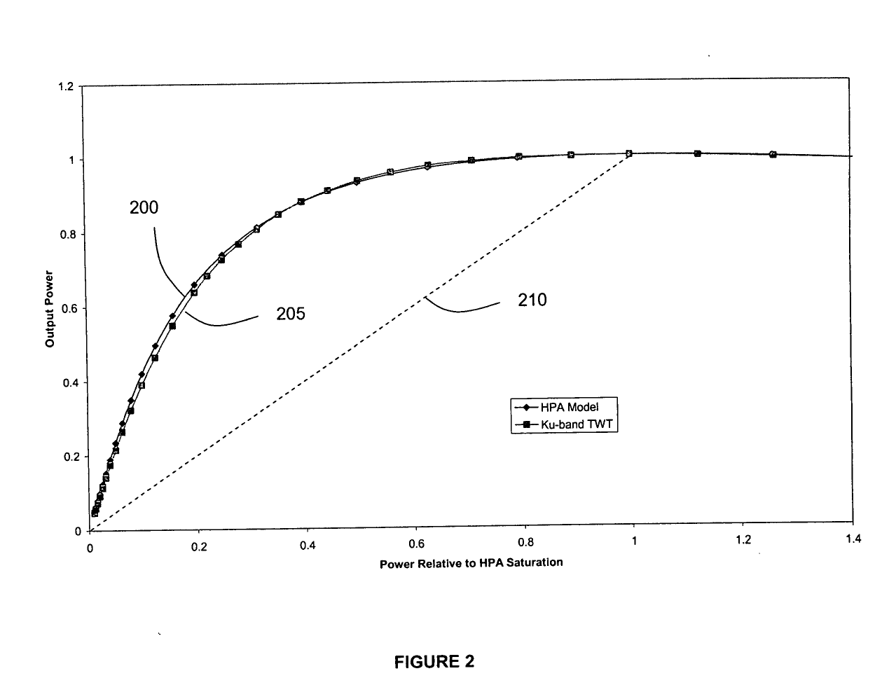

FIG. 2 shows a graphic representation of non-linear performance of a HPA in terms of output power as a function of input power (“AM-AM characteristic”);

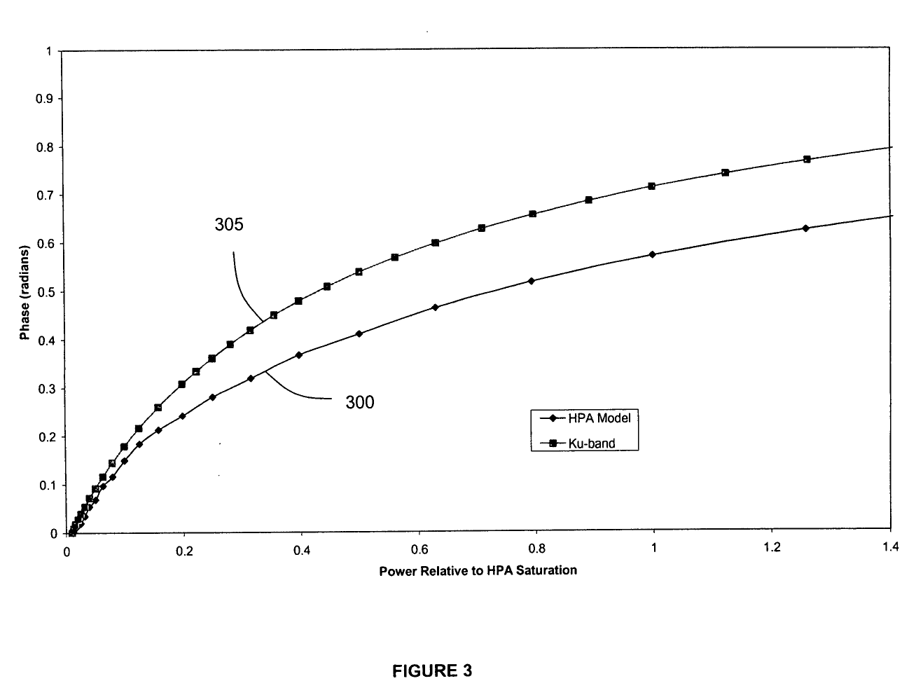

FIG. 3 shows a graphic representation of non-linear performance of a HPA in terms of phase shift in the output signal as a function of input power (“AM-PM characteristic”);

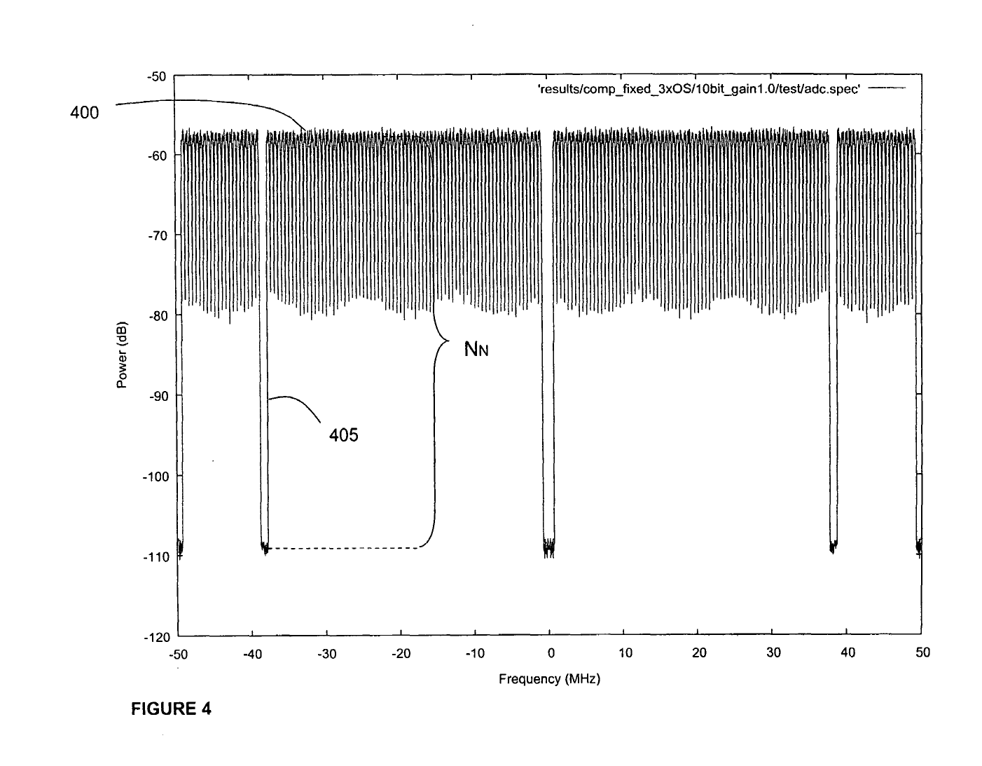

FIG. 4 shows the frequency spectrum of a test input signal, as a base band spectrum using real time domain data, for use with the lineariser of FIG. 1;

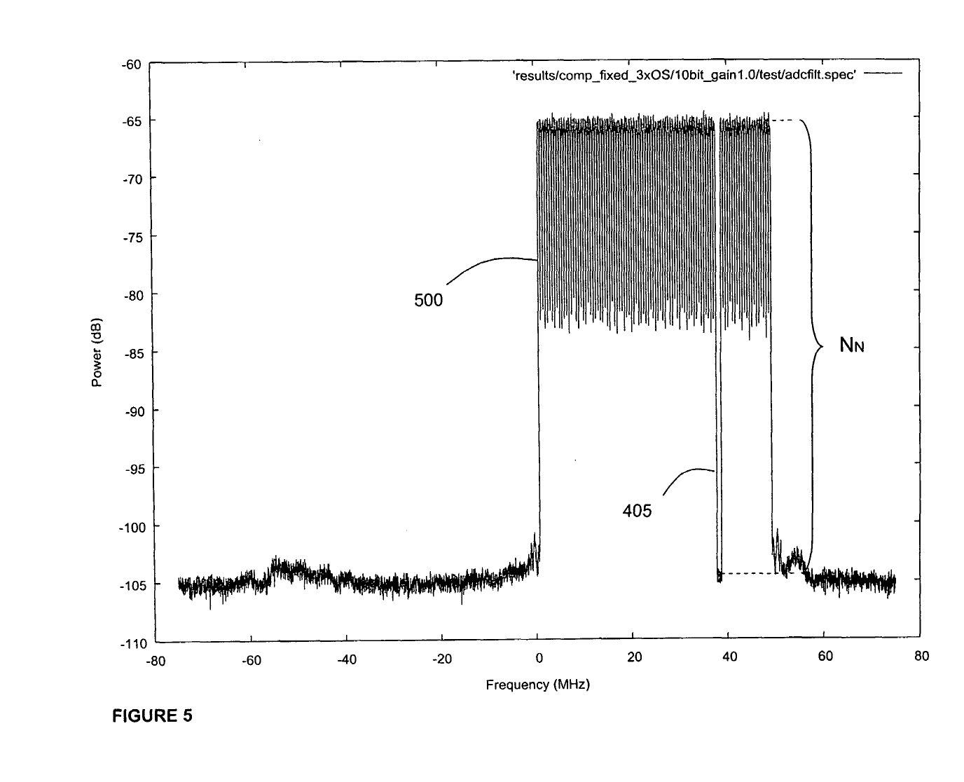

FIG. 5 shows the frequency spectrum of the test signal of FIG. 4 using complex time domain data after over-sampling and filtering of the test signal;

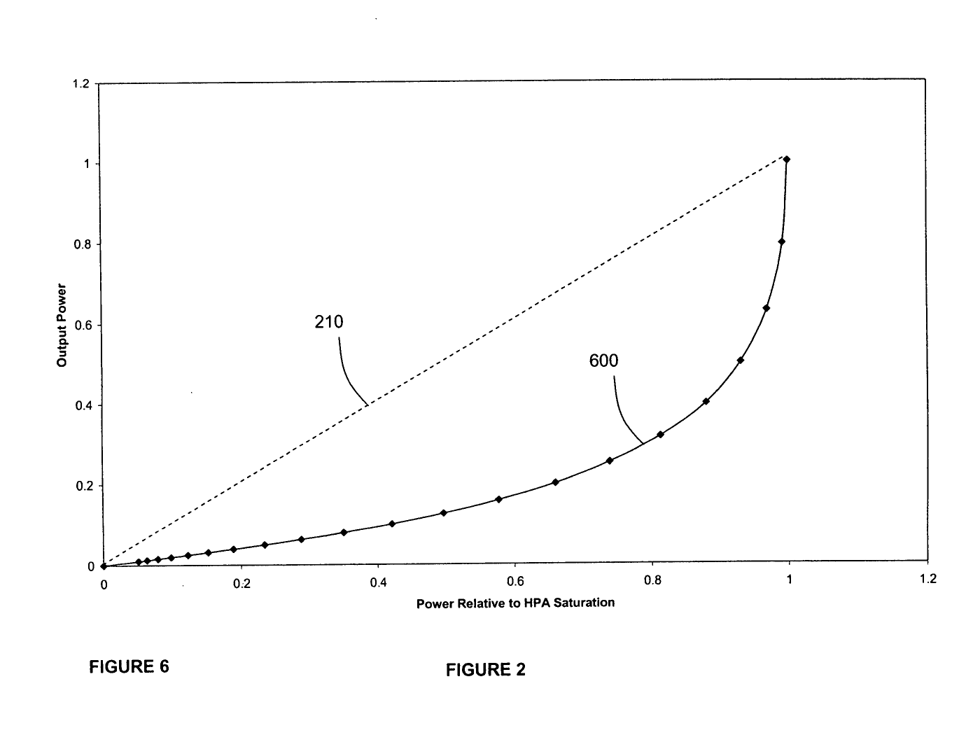

FIG. 6 shows a graphic representation of the AM-AM characteristic of the lineariser of FIG. 1;

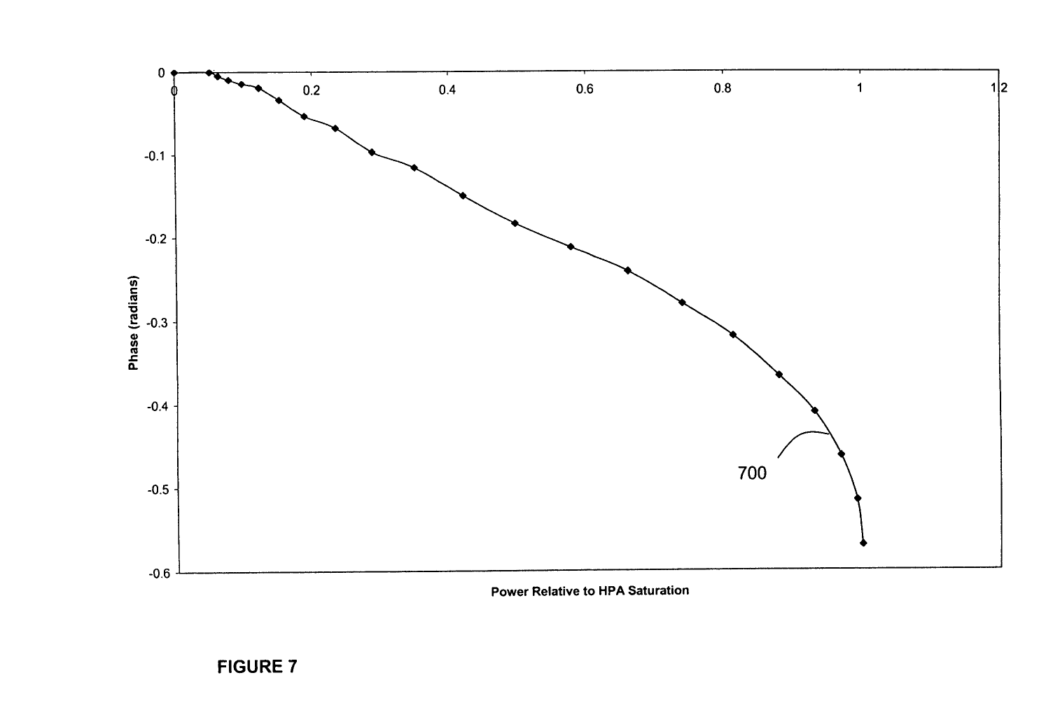

FIG. 7 shows a graphic representation of the AM-PM characteristic of the lineariser of FIG. 1;

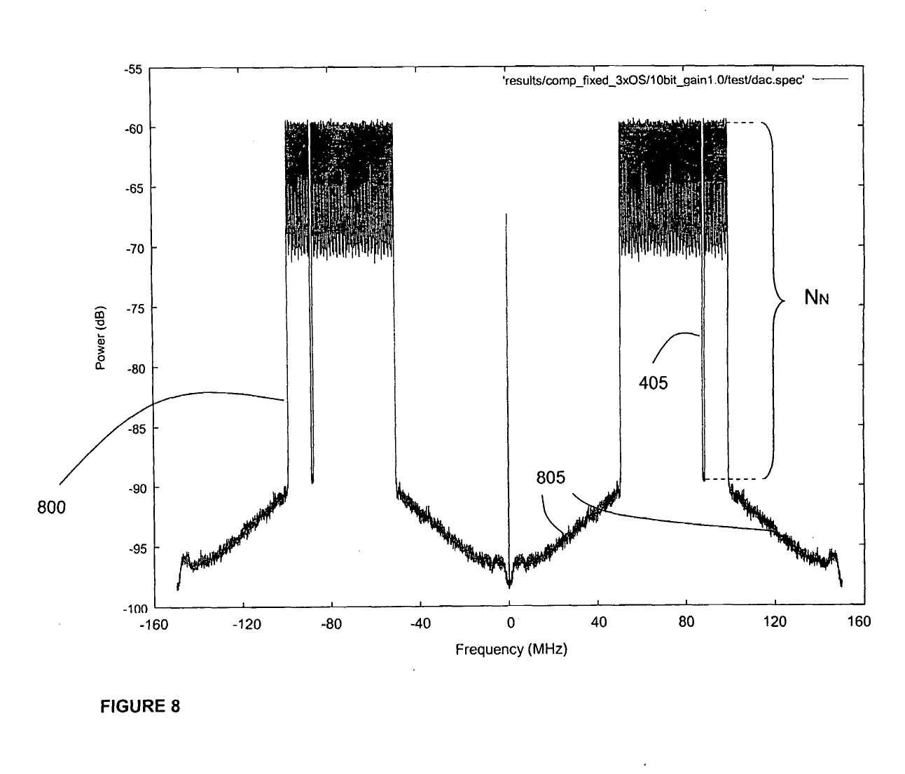

FIG. 8 shows the analogue frequency spectrum of the test signal of FIG. 5 after processing by the lineariser of FIG. 1, using real time domain data;

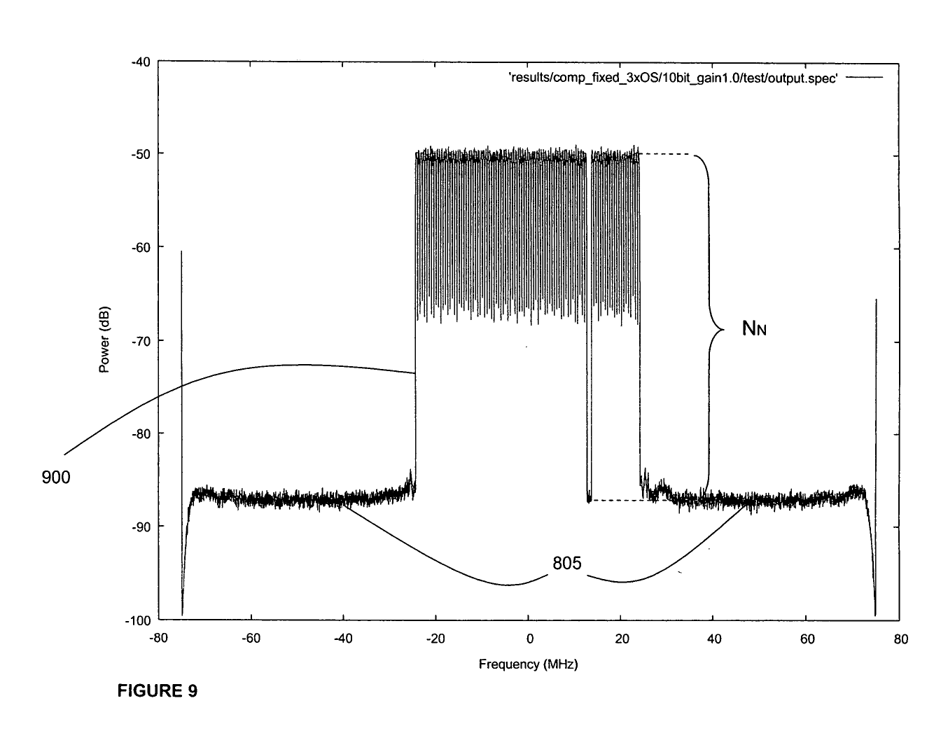

FIG. 9 shows the frequency spectrum of the linearised HPA output expressed in complex time domain data, using the test signal of FIG. 4;

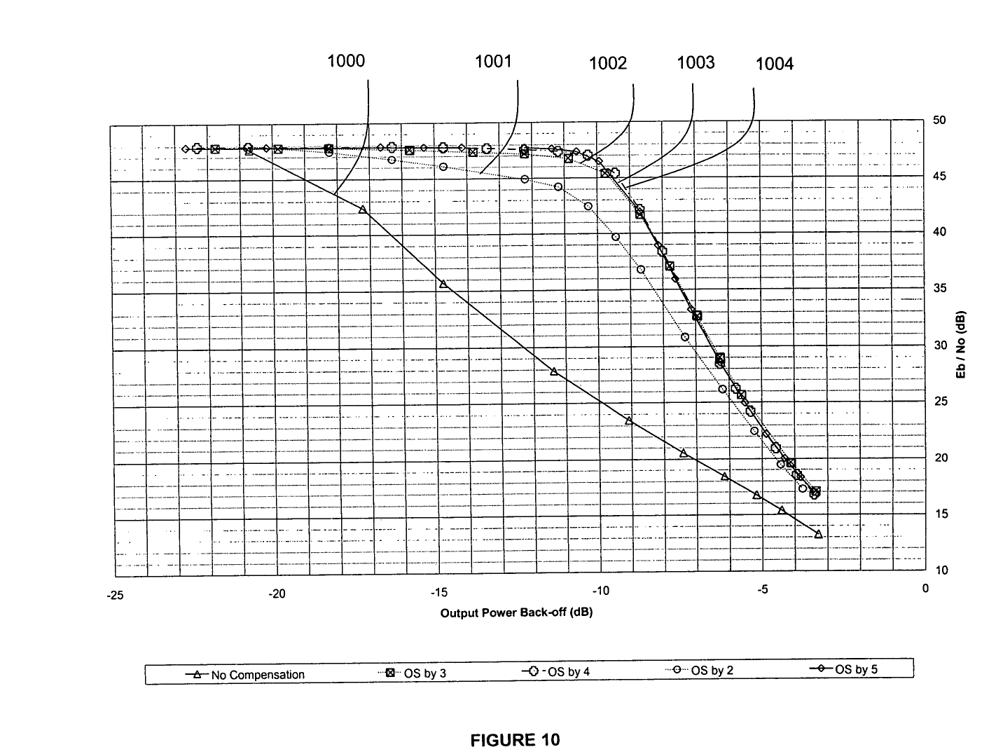

FIG. 10 shows a series of modelled results for carrier to noise ratio as a function of output backoff for different oversampling factors using floating point modelling and based on the test signal of FIG. 4;

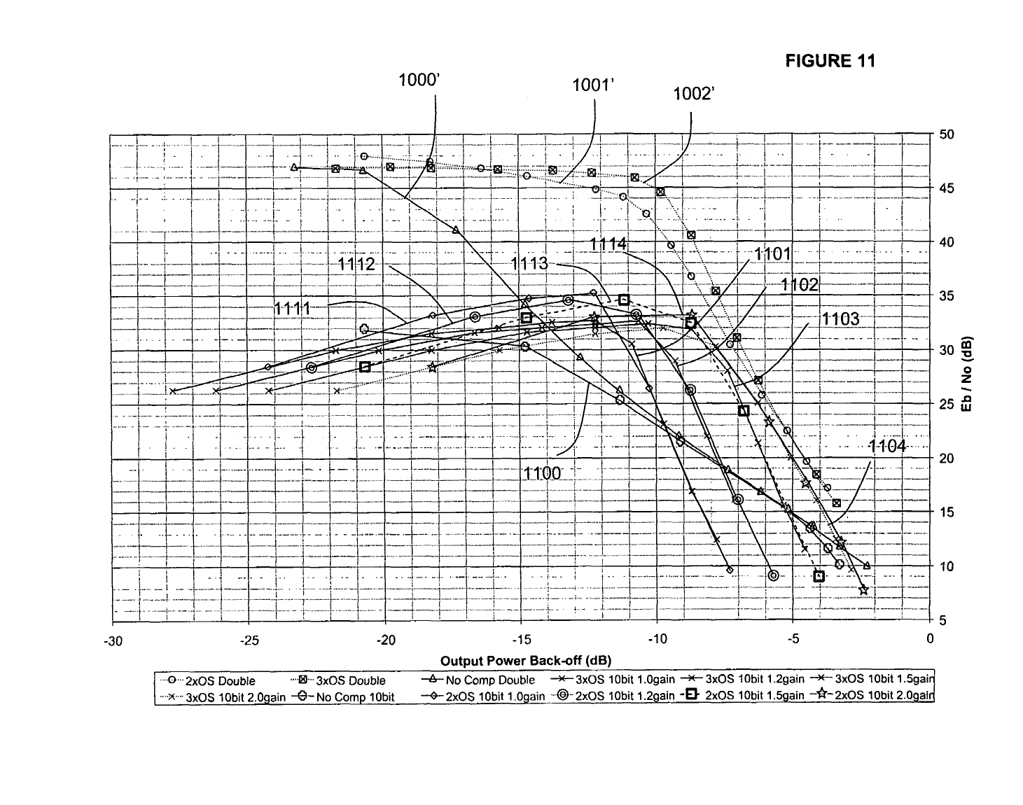

FIG. 11 shows a series of modelled results for carrier to noise ratio as a function of output backoff for different oversampling factors using “10-bit” precision in finite precision modelling and based on the test signal of FIG. 4;

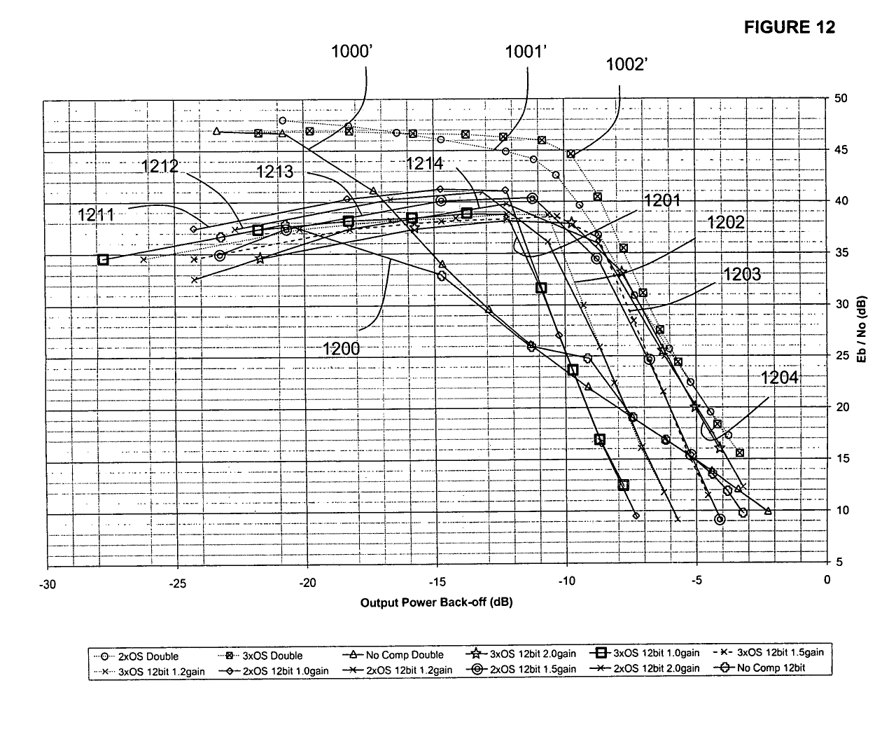

FIG. 12 shows the results of FIG. 11 but using “12-bit” precision in finite precision modelling; and

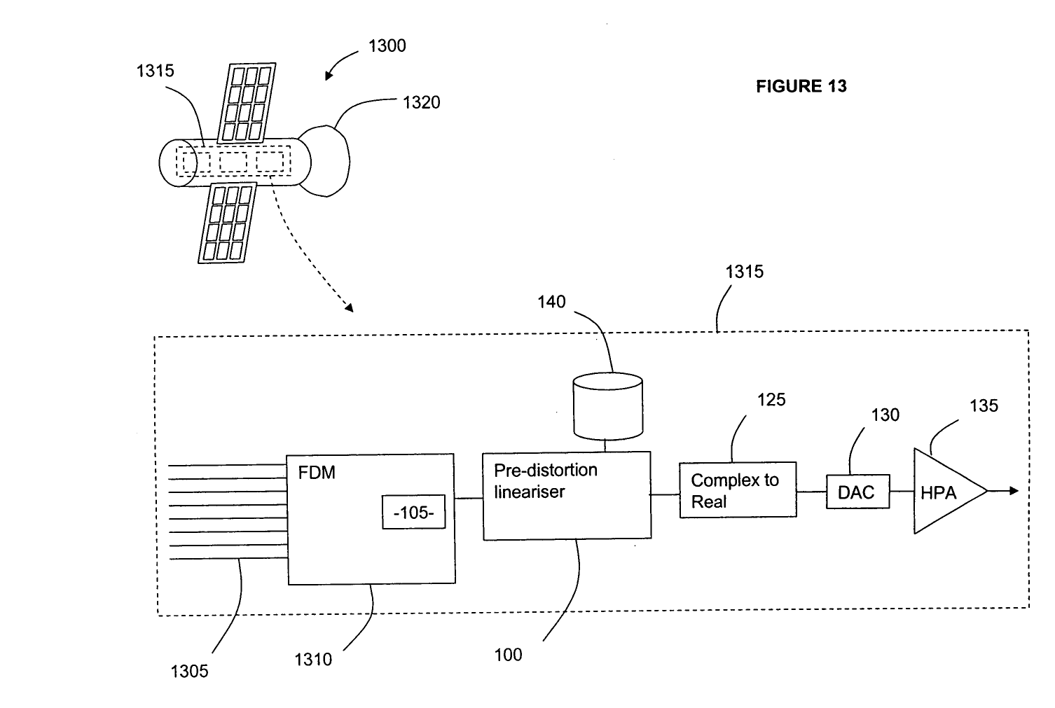

FIG. 13 shows a functional block diagram of primary components of the lineariser provided in conjunction with a multiplexer in a communications satellite.

### OVERVIEW OF PRIMARY COMPONENTS OF THE LINEARISER 100

Referring to FIG. 1, the basic operation of the lineariser 100 is as follows. The lineariser 100 receives an input signal, labelled in FIG. 1 as “C or R,1x”. As shown in FIG. 1, this input signal can be either complex or real. A rate setting arrangement such as an over-sampler 105 converts the input signal to an over-sampled, complex signal, labelled in FIG. 1 as “C,Nx”. An amplitude processor, shown in FIG. 1 as an amplitude measurer 115, creates a version of the over-sampled, complex signal “C,Nx” which is a set of (real) amplitude values, labelled in FIG. 1 as “A(R,Nx)”. A correction lookup device 120, or amplitude value converter, uses these amplitude values to find substitute values for insertion in the over-sampled, complex signal “C,Nx”, these substitute values being output as a complex data signal S(C,Nx) and used in a signal correcting processor, described below as a value substituter 110, to create a pre-distorted, or linearised, version L(C,Nx) of the over-sampled, complex signal “C,Nx”. This linearised signal L(C,Nx) is what goes forward to the HPA 135 in an otherwise known signal path comprising a complex to real signal converter 125 and a digital/analogue converter 130 (“DAC”).

In FIG. 1, for the purpose of clarity, complex signals are shown as double lines and real signals are shown as single lines. Additionally, the positions of signals shown graphically in others of the figures listed above are indicated on FIG. 1 by the relevant reference numerals and figure numbers, circled in dotted outline. For example, the over-sampled test signal whose frequency spectrum 500 is shown in FIG. 5 is marked on FIG. 1 at the output of the over-sampler 105.

### Components of the Lineariser 100

Referring further to FIG. 1, the input of the lineariser 100 is here represented by the input to the over-sampler 105. This receives a critically sampled, frequency multiplexed signal, such as the output of a digital signal processor (“DSP”) providing the multiplexing or an analogue source whose output has been converted to a critically-sampled complex time-series.

The over-sampler 105 may incorporate a filter which can provide real to complex conversion. Thus in practice the frequency multiplexed signal input to the over-sampler 105 may be represented by either complex or real time-domain data. Any suitable filter might be used from the field of digital signal processing, bearing in mind the well-established trade-off between performance and design simplicity. The over-sampler 105 might for example comprise a “poly-phase” filter with interpolation factor L and decimation factor M (complex input) or 2M (real input) giving a complex output over-sampled by L/M. The over-sampler 105 then provides a complex, over-sampled and rate-adjusted signal at its output.

The over-sampler 105 thus primarily provides a sample rate setting arrangement or mechanism. In some circumstances, it might receive a signal that is already over-sampled. What is important is that its output is a signal that has been over-sampled at a rate that supports the overall operation of the lineariser 100 in providing adequate pre-distortion to overcome for example in-band noise created at the amplifier 135 by out of band distortion created elsewhere in the signal processing path.

Although shown independently in FIG. 1, it will be understood that the over-sampler 105 might in practice be provided within the functionality of another component, such as a multiplexer for providing the frequency multiplexed signal mentioned above. Similarly, although the filter 152 is shown within the over-sampler 105 in FIG. 1, it could alternatively be provided independently of the over-sampler 105 in the signal processing path.

The over-sampler 105 is primarily used to set the sample rate to have an over-sampling factor “n” times the critical sampling rate. The factor “n” is not necessarily an integer and can take any rational value greater than unity (that is, any value L/M where L and M are positive integers and L/M>1). The over-sampling rate is further discussed below, for example with reference to FIG. 10. It is important that the bandwidth of the over-sampled signal should be sufficiently large (larger than the wanted signal bandwidth at the output of the HPA 135) to avoid aliasing of products arising in the signal processing path into the wanted band. It has been found however, for example in embodiments of the invention described below, that there might be little incremental advantage in setting the over-sampling rate above 3, or even indeed above 2.

The amplitude processor, or measurer, 115 is used to measure the amplitude of the over-sampled input signal in order to determine the pre-distortion, both amplitude and phase, to be applied. There are known forms of amplitude measurement and different techniques can be applied. A relatively efficient example is use of the CORDIC algorithm (the “co-ordinate rotation digital computer” algorithm) which estimates the amplitude of a complex sample by effectively rotating the sample close to the real axis. This is performed by a number of shift and add operations (the accuracy is directly related to the number of iterations) and thus, from the point of view of digital hardware, is less expensive than some alternative means of calculating the sample amplitude. The only caveat is that, in the limit of an infinite number of iterations, the calculated amplitude is larger than the true amplitude by a constant factor of approximately 1.64, which is a function only of the number of iterations; this must be borne in mind when calculating complex correction values for pre-distortion.

The CORDIC algorithm is an example of an algorithm that will support a correction scheme for memory-less amplifiers. That is, amplifiers whose degradations are solely a function of the instantaneous amplitude. Embodiments of the present invention are suitable for use with such amplifiers.

The correction lookup device 120 provides an amplitude value converter which has access to a form of memory or data store 140 such as read-only memory (“ROM”) or random access memory (“RAM”) for holding the amplitude and phase correction values, for example in the form of look-up tables “LUT” 141. Although the amplitude and phase correction values might be stored separately, it is efficient to use a single complex factor to express amplitude and phase correction in one value. The choice of using ROM or RAM storage will generally depend on whether there is a need for re-programming with respect to a pre-distortion characteristic.

The value substituter 110 is a complex-by-complex multiplier of any suitable type.

The complex to real signal converter 125 comprises a further filter of known type. As in the case of the over-sampler 105, the implementation of this filter 125 will be decided on the basis of the trade-off between performance and design simplicity. It will however be required to operate at the over-sampling rate applied by the over-sampler 105. An example might be a half-band, interpolate-by-two filter that retains only the real part of its output.

The digital/analogue converter 130 (“DAC”) again is of known type. In this case, the decision on a particular DAC will depend on more than one factor, such as performance, cost, power and band-width considerations.

### Non-Linearity of the HPA 135

FIGS. 2 and 3 show examples of the performance of an HPA 135 in relation to the input power of an analogue signal. FIG. 2 shows a relationship between output power and the input power relative to the saturation power level of the HPA 135 (AM-AM characteristic, amplitude being equal to the square root of the power). FIG. 3 shows a relationship between the phase of the output signal and the input power (AM-PM characteristic).

It can be seen that both amplitude and phase of the output signal are affected by the amplitude of the input signal power, which effects can therefore potentially be corrected at least to some extent by pre-distortion based on that input power.

FIG. 2 shows two curves, a first curve 205 being based on data released as “ESA ITT (AO/1-5465 Multi-Purpose Linearisers for TWTs)” by the European Space Agency in relation to a travelling-wave tube amplifier (“TWTA”). The second curve 200, closely similar, shows HPA characteristics on which subsequent description in the present specification is based.

FIG. 3 again shows two curves, a first curve 305 being based on the ESA data referenced above and a second curve 300 showing HPA characteristics on which subsequent description in the present specification is based. In this case, the second curve 300 shows a somewhat better phase response than the ESA curve 305.

In both figures, it might be noted that the power scale is linear with the input and the output saturation power is normalized to unity. (FIG. 2 shows a diagonal 210, in dotted line, between zero amplitude and the normalised saturation point for use in discussion below of pre-distortion, with reference to FIG. 6.) With regard to the ESA TWTA, for reference, the saturated output power is 52.03 dBm corresponding to an input power of −13.19 dBm.

It is widely accepted that non-linearity in an HPA is effectively memory-less and its performance may be accurately modelled in terms of its AM-AM and AM-PM characteristics. The effect of the non-linearity is to generate inter-modulation products which have a cumulative noise like effect. The inter-modulation products will exist within the input band (assumed to be the wanted signal) but will also extend outside the band with the extent being dependent on the order of the inter-modulation products. The dominant third order products extend over three times the wanted band.

It will be understood that compensation for non-linearity in an HPA can only be successful to any degree if the non-linearity is predictable to some extent. Information about an actual non-linearity to be compensated, within an expected range of performance in use of an HPA 135, can be obtained in any practical manner, for example from available literature or from workshop testing.

### Worked Example: Linearisation

HPA non-linearity is of particular concern when operating in multi-carrier mode. Referring to FIG. 4, a test signal for use in showing operation of the lineariser 100 might thus comprise a frequency division multiplex (FDM) of approximately 100 QPSK (quadrature phase shift keying) carriers, occupying a 50 MHz Nyquist bandwidth. In FIG. 4, this is shown as a baseband spectrum. Since the signal is real, the spectrum exhibits complex conjugate symmetry about zero frequency (negative spectrum amplitude is the mirror image of the positive spectrum and has opposite phase). This represents a large number of carriers. For test purposes, a gap or notch 405 has been left at around 38 MHz in order to measure the subsequent introduction of inter-modulation noise. The notch 405 shows a drop “NN” which is more than 50 dB down within the test signal.

It might be noted here that the finite signal-to-noise ratio (50 dB) is an intended component of the test signal, representative of a small amount of noise in the system, rather than a limitation of the modelling methods employed.

In practice, the input signal to the lineariser 100 will generally have been through earlier processing functions, such as digital frequency de-multiplexing, channel to beam routing, digital beam-forming and digital multiplexing, and will already incorporate noise other than inter-modulation noise.

Referring to FIG. 5, the over-sampler 105 provides a combination of up-sampling and digital filtering. The up-sampling factor is a user-defined parameter in the system being described, options being 2, 3, 4 and 5. FIG. 5 shows an example 500 of the resulting complex spectrum with an over-sampling factor of 3; that is, the sampled bandwidth is 150 MHz (represented by a complex sample rate of 150 Msam/s). The notch 405 has been retained but shows a reduced drop “NN” of about 40 dB down within the test signal.

It might be noted that, where the signal coming in to the lineariser 100 is a frequency division multiplex of a larger number of carriers, it will have constant (in the statistical sense) power and an approximately Gaussian distribution of amplitudes.

It might also be noted that the up-sampling factor is described above, and elsewhere herein, in relation to a signal received at the lineariser 100. In practice, the signal received at the lineariser 100 might have a bandwidth that depends on circumstances. The up-sampling factor will usually be set in relation to the overall bandwidth designed into a system incorporating the lineariser 100.

Referring to FIG. 6, the job of the lineariser 100 is to compensate for non-linearity in the HPA. FIG. 6 shows an AM-AM characteristic 600 of the lineariser 100, again with linear power axes, which is intended to compensate for the HPA characteristic 200 of FIG. 2. The AM-AM characteristic 600 of the lineariser 100 is the mirror image of the corresponding HPA curve 200 (referenced to the diagonal 210, also shown in FIG. 2, between zero amplitude and the saturation point) such that ideally the combined amplitude characteristics would be linear for samples up to the HPA saturation point.

Referring to FIG. 7, selecting the AM-PM characteristic 700 of the lineariser 100 is significantly different from selecting its AM-AM characteristic 600. Firstly, the AM-PM characteristic 700 of the lineariser 100 is being applied to cancel out the phase shift introduced by the HPA 135, not to linearise it in the manner of the amplitude response. Secondly, phase correction is applied together with the AM-AM characteristic 600. The amplitude measurer 115 is not measuring what the HPA 135 will see as its input signal since that will incorporate the AM-AM characteristic 600 of the lineariser 100. However, the AM-PM characteristic 700 of the lineariser 100 needs to correct phase in relation to what the HPA 135 will see as its input signal, working from what the amplitude measurer 115 measures. Hence the AM-PM characteristic 700 of the lineariser 100 has to take into account the AM-AM characteristic 600 of the lineariser 100 as well as the AM-PM characteristic 300 of the HPA 135. The AM-PM characteristic 700 of the lineariser 100 is therefore the inverse of the AM-PM characteristic 300 of the HPA 135, modified by the AM-AM characteristic 600 of the lineariser 100.

The AM-AM characteristic 600 and the AM-PM characteristic 700 of the lineariser 100 are both applied at the value substituter 110 shown in FIG. 1, to the signal whose complex spectrum is shown in FIG. 5.

### Quantisation Effects

It might be noted that the digital implementation of the lineariser 100 brings with it difficulties associated with fixed-precision arithmetic. For example, the finite precision of the complex multipliers applied in the value substituter 110 and of the signal amplitude calculations give rise to degradation. However, these quantisation effects can be diminished by increasing the precision of the digital words used until the degradation is deemed acceptable. A further problem is the limited dynamic range available in fixed-precision arithmetic. Typically, the samples of a wideband digital signal containing many carriers will assume a Gaussian-like distribution. It is clearly impossible to accommodate all possible sample values for even an arbitrarily low-powered signal since the tails of a Gaussian are of infinite extent. As a result, even ignoring small quantisation errors, the inability of fixed-precision words to represent the complete set of possible sample values gives rise to degradation. The degree of degradation caused will depend on how the digital samples are limited. Unfortunately, when limiting is applied to samples arising from the result of fixed-precision arithmetic it is usually done by “wrapping” the sample value, which yields more severe degradation than, say, simply saturating the sample value. Normally this behaviour is tolerated as long as the frequency of overflows (wrapping) is sufficiently small; that is, the probability of a given sample lying outside the digital word's range is low. In practice, this means limiting the power of the digital samples to about 10 dB below a full-scale deflection sine wave.

“Gain” with Regard to Full-Scale Deflection of the DAC 130

Given the above constraint on the power of the time-domain data in a digital processor, the mapping, via the DAC 130, of digital sample values to output analogue amplitude needs to be considered. Since it is impossible to compensate the HPA 135 beyond its saturation point (due to the many-to-one nature of the HPA AM-AM characteristic) it might be thought that the full-scale of the DAC 130 ought to be set to the saturation point of the HPA 135; this would effectively forbid the existence of digital samples whose value mapped to values equal to or larger than the saturation point. However, HPAs can routinely be operated at higher powers than 10 dB backed-off and these powers could not be attained without incurring intolerable degradation due to overflows in the digital processor. The solution to this is to set the full-scale deflection of the DAC 130 to be larger than the saturation point of the HPA 135. Any samples beyond the saturation point would experience degradation due to the HPA performance, but not by the amount they would have been subjected to if allowed to overflow in the digital processor. However, for a fixed digital word-length, increasing the analogue output amplitude of the full-scale deflection of the DAC 130 effectively compresses the digital samples into a smaller range of fixed-precision values, thus increasing the quantisation noise-floor relative to the signal: clearly there exists a complicated trade-off in optimising the signal-to-noise ratio involving digital overflows on one hand and quantization noise and compensation error on the other. Additionally, this trade-off will vary as a function of the desired output power. In the worked examples presented here a number of different analogue values for the full-scale deflection of the DAC 130 have been demonstrated and are discussed below with reference to FIGS. 11 and 12 where the analogue values are referred to as “gain values”. It should be noted that each different value requires a different look-up table because changing the full-scale deflection of the DAC 130 effectively imposes a gain between the lineariser 100 and the HPA 135.

### Worked Example: Amplification of Pre-Distorted Signal

In the following, the DAC 130 and the HPA 135 are themselves known components, operating in known manner. The HPA 135 would therefore in practice operate on an analogue signal. However, FIGS. 8 and 9 show digital representations of signals which have been pre-distorted in a lineariser 100 as described above, before and after passing through the HPA 135. These digital representations therefore model the signal and noise content of the relevant analogue signal as it passes through the HPA, having been pre-distorted.

Referring to FIG. 8, a real spectrum 800 representing an analogue signal at the output of the DAC 130, where a factor of 3 was used at the over-sampler 105, is 300 MHz wide. This real spectrum 800 shows inter-modulation noise shoulders 805 extending either side of the wanted spectrum resulting from the linearization processing. These shoulders 805 are only about 30 dB down on the wanted spectrum at the point where they are closest in frequency. The notch 405 shows a drop “NN” which is only 30 dB down within the test signal, being partially filled by inter-modulation noise which is representative of that lying on the occupied carriers.

The samples have been converted to floating point arithmetic at this point to denote a shift to modelling of analogue sections of the system. However, the spectrum is converted to complex form in order to model the effect of the HPA 135. In the following, the over-sampling factor for the HPA 135 is the same (three) as that used earlier, at the over-sampler 105.

Referring to FIG. 9, a spectrum 900 based on complex time-domain data and representing the output of the HPA 135 shows a reduction in the inter-modulation noise shoulders 805. This demonstrates the impact of the lineariser pre-distortion in reducing the HPA inter-modulation noise. The shoulders 805 are now about 37 dB down on the wanted spectrum. The notch 405 shows a drop “NN” which is about 38 dB down within the test signal, an improvement of 8 dB with regard to the un-amplified signal which contained pre-distortion.

### Results

Main indicators of the performance of linearisers 100 of a type as described above are the in-band inter-modulation noise due to the HPA 135 and the ability of the linearization to reduce it. Measurements can be made in two essentially equivalent ways:
Noise Power Ratio (“NPR”) measurement. As discussed earlier, an empty slot 405 can be introduced into a test signal 400 comprising a frequency division multiplex (“FDM”). Assuming that the level of noise in the slot 405 is representative of the level that will lie on the wanted carriers of the signal 400, the power in the slot after the HPA 135 should represent primarily the level of inter-modulation noise (provided that the sample rate of the over-sampler 105 is high enough to avoid significant aliasing).
In a modelled system, it can be possible to measure a carrier to noise ratio (referred to as “Eb/No” below) directly for a given carrier and this can be modelled taking different factors into account.

Taking NPR results first, these have been mentioned above. The notch 405 shows a drop “NN” which is affected by processing of the initial test signal in relation to different points through the system of FIG. 1. Taking the measurements of “NN” mentioned above in turn:
1. Initial test signal—“NN” is more than 50 dB
2. After over-sampling (by 3) and filtering—“NN” is 40 dB
3. After pre-distortion and the DAC 130—“NN” is 30 dB
4. After the HPA 135—“NN” is about 38 dB

The initial test signal, shown in FIG. 4, is an artificially “clean” signal for test purposes only. In practice, the incoming signal to the lineariser 100 would already have undergone processing and would carry more noise.

In general, these results for “NN” indicate that the pre-distortion applied by the lineariser successfully counteracts noise introduced by the HPA in a wanted carrier range. However, a more detailed analysis is given below with reference to FIG. 10 in which the situation with and without the lineariser is discussed.

The alternative method using “Eb/No” is a more sophisticated metric which measures the degradation experienced by a receiver of one of the QPSK carriers.

Referring to FIGS. 10 to 12, results are presented in terms of plots of Eb/No versus output power back-off (OBO) of the HPA 135. In each case, the results are based on modelling of the performance of a system based on that shown in FIG. 1. In the case of FIG. 10, floating point arithmetic is used in the modelling in order to provide a bound on the optimum performance that can be achieved with a given level of over-sampling. In the cases of FIGS. 11 and 12, finite precision modelling is used, with different respective word-lengths between and within the simulation blocks. The two sets of precision values have been chosen in order to give an indication of the degree of precision required in digital signal processing prior to the HPA 135 in a working embodiment of the invention to compensate the HPA 135 to a reasonable degree. FIG. 11 shows results using 10-bit precision between the simulation blocks together with precision within the simulation blocks appropriate to that 10-bit precision, while FIG. 12 shows results using 12-bit precision between the simulation blocks together with precision within the simulation blocks appropriate to that 12-bit precision.

It should be noted that the modelling which provides the basis of FIGS. 10 to 12 has not been extensively optimised. These results are only intended to give an indication of the potential benefit of a working embodiment of the invention, including the effect of the level of precision selected in a digital signal processing system preceding the HPA 135.

In these figures, parameters are varied as follows:
over-sampling factors
word-lengths between digital blocks as discussed above, FIGS. 11 and 12 only
gain values (analogue values for full-scale deflection of the DAC 130), FIGS. 11 and 12 only

Referring to FIG. 10, five curves for Eb/No versus OBO are shown as follows:

Curve 1000: no linearisation provided by the lineariser 100

Curve 1001: linearisation with over-sampling factor 2

Curve 1002: linearisation with over-sampling factor 3

Curve 1003: linearisation with over-sampling factor 4

Curve 1004: linearisation with over-sampling factor 5

It might be noted that these results are based on the use of an analogue to digital converter (“ADC”) (not shown) having 10 bit precision and thus introducing quantisation noise.

Features of the curves of FIG. 10 are:
at OBO greater than about 20 dB, Eb/No saturates at about 48 dB due the quantisation noise floor of the ADC
without linearisation, Eb/No reduces as OBO reduces, the noise corresponding here to the inter-modulation noise spectral density from the HPA 135
with linearization, for a broad range of OBO values, about 3 to 20 dB, Eb/No is significantly increased, corresponding to a decrease in inter-modulation noise
the improvement in Eb/No increases with the over-sampling factor but there is minimal improvement beyond an over-sampling factor of 3

In an example of the last point above, at OBO 10 dB, linearization at an over-sampling factor of 3 increases Eb/No from 25 dB to 46 dB. Looking at this as a potential reduction in OBO, to achieve Eb/No at 30 dB, the OBO can be reduced from 12.5 dB to only 6.5 dB. (It should be noted though that this relates only to inter-modulation noise and not to thermal noise which varies with HPA power levels.)

Referring to FIG. 11, in a modelled system based on 10-bit precision, three curves from the floating point arithmetic model (using the double precision arithmetic of the software language C++) of FIG. 10 are included for comparison, as follows:

Curve 1000′: no linearisation provided by the lineariser 100

Curve 1001′: linearisation with over-sampling factor 2

Curve 1002′: linearisation with over-sampling factor 3

The rest of the curves in FIG. 11 are based on the following:

Curve 1100: no linearisation and zero gain

Curve 1111: linearisation with over-sampling factor 2, gain 1.0

Curve 1112: linearisation with over-sampling factor 2, gain 1.2

Curve 1113: linearisation with over-sampling factor 2, gain 1.5

Curve 1114: linearisation with over-sampling factor 2, gain 2.0

Curve 1101: linearisation with over-sampling factor 3, gain 1.0

Curve 1102: linearisation with over-sampling factor 3, gain 1.2

Curve 1103: linearisation with over-sampling factor 3, gain 1.5

Curve 1104: linearisation with over-sampling factor 3, gain 2.0

In FIG. 11, the Eb/No values are due to a combination of inter-modulation noise and quantization noise associated with the finite precision modelling. The Eb/No saturation is at a lower level (about 32 dB) as a result of the finite precision modelling. A curve 1100 is included for the case without linearization and converges with the equivalent floating point curve 1000′ at low OBO where the dominant source of noise is inter-modulation; at higher OBO the Eb/No is lower than in the floating point case because of the additional quantization noise effects.

There are then four pairs of finite precision curves corresponding to different gain values (1.0, 1.2, 1.5 and 2.0) with each pair corresponding to over-sampling factors of 2 and 3. It is noted that the improvement relative to the un-linearised case (curve 1100) increases with higher gain factor and for a gain of 2.0 (curves 1104, 1114) the result is close to the linearised floating point case (curves 1001′, 1002′). The advantage in increasing the over-sampling factor from 2 to 3 is relatively small (not shown).

Referring to FIG. 12, the results shown in FIG. 11 are repeated but using a modelled system based on 12-bit precision. The curves shown in FIG. 12 are as follows:

Curve 1200: no linearisation and zero gain

Curve 1211: linearisation with over-sampling factor 2, gain 1.0

Curve 1212: linearisation with over-sampling factor 2, gain 1.2

Curve 1213: linearisation with over-sampling factor 2, gain 1.5

Curve 1214: linearisation with over-sampling factor 2, gain 2.0

Curve 1201: linearisation with over-sampling factor 3, gain 1.0

Curve 1202: linearisation with over-sampling factor 3, gain 1.2

Curve 1203: linearisation with over-sampling factor 3, gain 1.5

Curve 1204: linearisation with over-sampling factor 3, gain 2.0

In FIG. 12, it can be seen that the saturation level is higher (around 38 dB) due to the reduced quantization noise. The improvement due to the linearization, that is compared to the un-linearised curve 1200, is better than in the 10 bit case, again with the higher gain case showing the greater improvement.

Looking at the level of improvement in slightly more detail, this may depend for example on the inter-modulation noise performance that can be tolerated. If the maximum Eb/No is 20 dB, in the un-linearised case (curves 1100, 1200) for both 10 and 12 bit precision, the OBO is about −8 dB. From FIGS. 11 and 12 it can be seen that for a gain of 2, the OBO can be reduced in the case of both 10 bit and 12 bit precision by 3 dB for an over-sampling factor of 2 or 3. If the maximum Eb/No is increased to 30 dB however, linearization with gain 2 allows the OBO to be reduced by 6 to 7 dB.

To put this result into context, for a TWTA that can be used as the HPA 135 and as described in “ESA ITT (AO/1-5465 Multi-Purpose Linearisers for TWTs)”, the DC (direct current) power is approximately 130 W at 5 dB OBO (output power of 47 dBm, ie 50 W) and 100 W at 8 dB OBO (output power of 44 dBm, ie 25 W). Thus the efficiency of such a HPA 135 without linearization according to an embodiment of the present invention would be 25% whilst with an improvement of 3 dB in OBO delivered by linearization according to an embodiment of the present invention, the efficiency would be 39%.

It will be understood however that other factors than inter-modulation noise affect performance in communication systems, such as downlink thermal noise which tends to increase when the OBO is increased. Typically, downlink performance requirements may be expressed in terms of an Eb/No where No includes both thermal and intermodulation noise. These noise effects should ideally be balanced in an optimum way. Reducing the OBO (increasing the transmit power) serves to increase the thermal Eb/No (dB for dB) but decreases the intermodulation Eb/No. In a simple illustrative example, the Eb/No requirement is assumed to be 17 dB with equal contributions from thermal and intermodulation noise (ie both have Eb/No requirements of 20 dB). As discussed above, without linearization, the curves shown in FIGS. 11 and 12 indicate that an OBO of 8 dB would be required with the corresponding transmit power assumed to be adequate to provide a thermal Eb/No of 20 dB given the other link budget parameters. With linearization using gain factor 2, the intermodulation Eb/No requirement of 20 dB can again be achieved with an OBO of 5 dB (that is, a 3 dB reduction in OBO). Thus double the power is available which would be sufficient to support twice the capacity with the same overall noise performance. Alternatively the same amount of capacity could be provided with an amplifier with 3 dB less saturated power and 3 dB less OBO.

### Correction Characteristics

In the above, correction characteristics used for pre-distortion, such as look-up-tables stored in the correction lookup device 120, can be derived either from experimental data or from expressions. Principles that can be used in arriving at the correction characteristics are as follows.

Let the time-series input to the pre-distorter 100 be represented by complex values “z”, these being a complex digitised representation of the frequency multiplex to be passed through the HPA 135 as a real analogue signal.

To determine the pre-distortion, consider an equivalent digital model of the HPA 135 and its action on z. This may be expressed as

z=re^{iφ}→H(z)=A(r)e^{i(φ+θ(r))},

where:
H(z) is the equivalent digital complex response of the HPA 135 to a sample z,
A(r) is a real-valued function that defines the amplitude response of the HPA, and
θ(r) is a real-valued function defining the phase response of the HPA.

A(r) and θ(r) may be derived from a model of the HPA 135 or from empirical data. (Note that A(r) and θ(r) would both be constant for an ideal amplifier.)

Consider first the linearisation of the amplitude characteristic. Let the net (linear) gain of the pre-distorter 100 and the HPA 135 be G, that is, an input amplitude of r will be mapped to the net output Gr by the combination of the pre-distorter 100 and the amplifier 135. From the amplitude response of the amplifier 135, the output amplitude of the pre-distorter 100, r′, is related to Gr by

Gr=A(r′)

Hence the output characteristic of the pre-distorter 100 is defined simply by

r′(r)=A⁻¹(Gr).

In the case where only an empirical definition is available for A(r), this inversion will have to be carried out numerically and probably will involve some numerical interpolation.

To equalise the phase response, it is simply necessary to undo the θ(r) rotation applied by the amplifier 135 by an equal but opposite phase rotation.

However, since the output of the pre-distorter 100 has an amplitude r′, not r, it is necessary to ensure that the phase is rotated by

φ→φ−θ(r′)=φ−θ(A⁻¹(Gr)).

### General Points

It will be understood that the lineariser 100 as described above would in practice be installed in relation to a HPA 135 for example in a satellite communications system. A digital processor architecture might then typically include a digital multiplexing function to generate a frequency division multiplex (“FDM”) of output carriers with critical sampling according to the bandwidth of the FDM. With linearization according to an embodiment of the present invention, the multiplexer output would need to be over-sampled, either by incorporating oversampling in the multiplexer function or by using a separate over-sampling filter after the multiplexer. Hence the sample rate setting arrangement of a signal pre-processor according to an embodiment of the present invention could in practice be provided within a multiplexer for generating a FDM of carriers.

Referring to FIG. 13, in an embodiment of the invention installed on a satellite 1300 and as described above, a signal processing path 1315 takes a set of carriers 1305 as input. A multiplexer 1310 converts these to a FDM with a sampling rate determined by a rate setting arrangement 105 within the multiplexer 1310. The multiplexer 1310 outputs an over-sampled signal to the pre-distortion lineariser 100 which then operates as described above, but without the need for additional oversampling, to generate a pre-distorted signal for supply to the HPA 135 and thus to an antenna or antenna array 1320 of the satellite 1300.

It will be understood that the advantage in terms of amplifier efficiency and/or capacity of linearization according to an embodiment of the invention must be compared with the additional overhead in terms of digital processing. Whilst the approach could be applied to a system architecture which otherwise does not include digital processing, it is more advantageous in the context of a system which uses digital processing for some other purpose. In the latter case there is no general overhead in introducing digital processing into the system.

Additional processing is associated with the lineariser 100 itself, together with additional memory for the amplitude value converter 120 such as one or more LUTs. However, with the advent of deep sub-micron ASIC (application specific integrated circuit) technology, additional processing is becoming less important with respect to additional power. An LUT is easily updated and this approach is therefore attractive in terms of optimizing linearization during a mission lifetime in accordance with any drifts in HPA characteristics.

A scenario in which embodiments of the present invention could be applied is a system where the output is typically associated with an antenna beam port with a single HPA per beam. However the approach has application in other circumstances. For example, it would be possible to use an embodiment of the present invention in relation to active antennas where the outputs relate to antenna elements or feeds. A transmit direct radiating array (“DRA”) typically has a dedicated HPA per element and all the carriers contribute to a given element signal, typically with digital beam-forming being included within the supporting processor. In this case, digital linearization could be applied on the basis of individual DRA elements and linearization could be optimized according to any variations in HPA characteristics.

1. A signal pre-processor for an amplifying system, for use in providing a multiplexed, multi-carrier signal to an amplifier to give an amplified signal comprising a wanted frequency range, the pre-processor comprising:
a) a sample rate setting arrangement for providing a digital, multiplexed signal as an over-sampled signal in complex form, the signal being over-sampled with respect to the wanted frequency range;
b) an amplitude processor for receiving the over-sampled signal and processing it to obtain a set of amplitude values;
c) an amplitude value converter for converting at least some of the amplitude values to complex correction values; and
d) a signal correcting processor for applying the complex correction values to the over-sampled signal to create a pre-distorted digital signal, prior to amplification by the amplifier,
such that signal distortion in the amplified signal can be at least partially avoided.

2. A pre-processor according to claim 1, wherein the multi-carrier signal comprises a frequency-multiplexed signal.

3. A pre-processor according to claim 1, further comprising a filter for use in converting a real signal to provide the over-sampled signal in complex form.

4. A pre-processor according to claim 1 wherein the sample rate setting arrangement includes a filter for use in converting a real signal to provide the over-sampled signal in complex form.

5. A pre-processor according to claim 1 wherein the amplitude value converter comprises a data reader for reading correction values in relation to the amplitude values from a data store.

6. A pre-processor according to claim 1 wherein the amplitude value converter has access, in use, to complex correction values which at least partially correct noise otherwise capable of aliasing into the wanted frequency range at the output of the amplifier.

7. A pre-processor according to claim 1 wherein the amplitude processor is adapted to process the over-sampled signal to obtain a set of real amplitude values.

8. A pre-processor according to claim 1 wherein the sample rate setting arrangement provides, in use, a signal oversampled at a rate to give not more than three times the critical sampling rate of the wanted frequency range.

9. A pre-processor according to claim 1 wherein the sample rate setting arrangement provides, in use, a signal oversampled at a rate to give not more than twice the critical sampling rate of the wanted frequency range.

10. A pre-processor according to claim 1 wherein the signal correcting processor applies amplitude correction such that the pre-distorted signal comprises an amplitude-corrected signal which differs in amplitude from the over-sampled signal.

11. A pre-processor according to claim 1 wherein the signal correcting processor applies phase correction such that the pre-distorted signal comprises a phase-corrected signal which differs in phase from the over-sampled signal.

12. A pre-processor according to claim 11 wherein the phase correction is applied in respect of the amplitude-corrected signal.

13. A pre-processor according to claim 1 wherein the amplitude value converter is adapted to convert all of the amplitude values to complex correction values.

14. A pre-processor according to claim 1, further comprising a digital to analogue converter for converting a signal comprising the pre-distorted signal to an analogue signal prior to input to the amplifier.

15. A pre-processor according to claim 14 wherein the full scale deflection of the digital to analogue converter is set, in use, to be larger than the saturation point of the amplifier.

16. A pre-processor according to claim 1, for use in a communications satellite.

17. An amplifying system comprising a pre-processor according to claim 1, wherein the amplifier is a high power amplifier.

18. A communications satellite having a digital processor architecture and comprising a digital multiplexer for generating a multiplex of carriers, the satellite further comprising a pre-processor according to claim 1.

19. A communications satellite according to claim 18 wherein the digital multiplexer provides the sample rate setting arrangement of the pre-processor.

20. A method of processing a multiplexed, multi-carrier signal, for use in providing a pre-distorted signal to an amplifier for amplification to give an amplified signal comprising a wanted frequency range, the method comprising:
a) receiving the multiplexed signal and processing it to provide an over-sampled digital signal in complex form;
b) processing the over-sampled signal to obtain a set of amplitude values;
c) converting at least some of the amplitude values to complex correction values; and
d) applying the complex correction values to the over-sampled digital signal to create the pre-distorted signal,
such that signal distortion in the amplified signal is at least partially avoided.

21. A method according to claim 20, wherein step a) comprises over-sampling with respect to the wanted frequency range.

22. A method according to claim 20, wherein the multi-carrier signal comprises a frequency-multiplexed signal.

23. A method according to claim 20, wherein step a) comprises filtering to convert a real signal to provide the over-sampled signal in complex form.

24. A method according to claim 20, wherein step c) comprises reading correction values in relation to the amplitude values from a data store.

25. A method according to claim 20, wherein the complex correction values at least partially correct noise otherwise capable of aliasing into the wanted frequency range at the output of the amplifier.

26. A method according to claim 20, wherein the over-sampled digital signal is over-sampled at a rate to give not more than three times the critical sampling rate of the wanted frequency range.

27. A method according to claim 20, wherein the over-sampled digital signal is over-sampled at a rate to give not more than twice the critical sampling rate of the wanted frequency range.

28. A method according to claim 20 wherein the complex correction values provide both amplitude and phase correction.

29. A method according to claim 20, further comprising the step of converting a signal comprising the pre-distorted signal to an analogue signal prior to input to the amplifier.
